(19) United States
(12) Patent Application Publication
(10) Pub. No.: US 2021/0270293 A1
(43) Pub. Date: Sep. 2, 2021

(54) A CONTROL VALVE ASSEMBLY FOR A LOAD HANDLING VEHICLE

(71) Applicant: PARKER HANNIFIN EMEA S.A.R.L., Etoy (CH)

(72) Inventors: Andries Broekx, Genk (BE); Paul Leadly, Somerset (GB); Thomas McCann, Leeds (GB)

(21) Appl. No.: 17/259,372

(22) PCT Filed: Jul. 11, 2019
(86) PCT No.: PCT/EP2019/068767

§ 371 Date: Jan. 11, 2021

(30) Foreign Application Priority Data
Jul. 11, 2018 (GB) 1811366.2

(51) Int. Cl. F15B 11/042; F15B 1/26

(52) U.S. Cl. CPC F15B 11/042; F15B 2211/41; F15B 2211/428; F15B 1/26

(57) ABSTRACT

A control valve assembly for a load handling vehicle such as forklift comprises a valve body having a bore and a spool located within the bore that is axially movable along the bore between at least two operating configurations. The valve body includes a service port connected to a hydraulic actuator, a pressure port connected to a pump, and a tank port connected to a hydraulic tank reservoir. The valve is reconfigurable between first and second operating configurations. In the first operating configuration the spool defines a fluid pathway connecting the pump port, the service port and the tank port such that in a first flow direction fluid is able to flow from the pressure port to the service port and the tank port, and in a second flow direction fluid is able to flow from the service port to the pressure port and the tank port. The spool is also controllable in the first operating configuration to variably restrict flow to the tank port. In the second operating configuration the spool defines a fluid pathway connecting the pressure port and the actuator port, and is controllable to variably restrict flow between the pressure port and the actuator port.

The present invention relates to a control valve assembly for a load handling vehicle, and method for operating the same.

Electric load handling vehicles such as electric forklift trucks or electric order pickers include an electrical drive means for providing motion to the vehicle and a hydraulic system for providing power to hydraulic actuators such as the lifting circuit of a forklift. An electric forklift truck includes a primary hydraulic actuator for vertically raising and lowering a load. The primary lifting actuator is driven by a hydraulic pump via a primary hydraulic circuit. The primary hydraulic circuit will typically be arranged to provide pressurised hydraulic fluid directly to the primary actuator from the pump, as the primary hydraulic actuator operates under the greatest load pressure. In addition to the vertical raising and lowering of the load, a load handling vehicle will commonly include auxiliary hydraulic actuators for performing additional functions such and forward and rearward reach, or lateral and/or transverse tilt of the load.

The primary and auxiliary cylinders have differing and often simultaneous fluid supply demands. In order to minimise the cost and size of the hydraulic system it is desirable to be able to run both the primary and auxiliary cylinders using a single pump. A flow sharing system is therefore required to enable a plurality of hydraulic cylinders to be operated simultaneously under different load conditions. It is also desirable to be able to use the lowering load pressure to operate the auxiliary cylinders when an auxiliary function is required during lowering, as an alternative to using electric energy to drive the pump.

It is also known provide electric load handling vehicles with the capacity for energy regeneration during hydraulic lowering of the load. In such systems the hydraulic pressure during lowering may be used to operate a motor generator to generate electricity.

A hydraulic system of an electric load handling vehicle is therefore required that is configured to accommodate the above requirements. The hydraulic system must include flow control devices, including numerous valves, to manage the flow sharing requirements. Typically, a flow sharing hydraulic system for an electric vehicle comprises several valves configured to control varying aspects of the flow control system, which cooperate to provide the required flow control functionality. A control algorithm is also required to control the separate valves, and an increase in the number of valves and other control elements makes the control algorithm significantly more complex to implement and program. In addition, the electronic control system and hardware needs to be capable of driving multiple currents proportionally.

There are numerous ways in which a hydraulic system may arranged to achieve the necessary functionality. However, in order to minimise the cost of the system, and the maintenance requirements, it is desirable to minimise the number, size and complexity of the flow control elements, which also has the effect of reducing the cost and complexity of the algorithms required to control the hydraulic system.

It is therefore desirable to provide an improved a control valve assembly for a load handling vehicle which addresses the above described problems and/or which offers improvements generally.

According to the present invention there is provided a control valve assembly for a load handling vehicle as described in the accompanying claims. In accordance with the present invention there is also provided a method of flow control for a load handling vehicle as described in the accompanying claims.

In an embodiment of the invention there is provided a control valve assembly for a load handling vehicle such as forklift. The control valve comprisesa valve body having a bore and a spool located within the bore that is axially movable along the bore between at least two operating configurations. A service port is formed in the valve body and arranged for connection to a hydraulic consumer such as a hydraulic actuator. A pressure port is also formed in the valve body and arranged for connection to a hydraulic power provider such as a pump. In addition, a tank port is formed in the valve body and arranged for connection to a hydraulic tank reservoir. The valve is reconfigurable between a first and second operating configurations. In the first operating configuration the spool is configured and arranged to define a fluid pathway connecting the pump port, the service port and the tank port such that in a first flow direction fluid is able to flow from the pressure port to the service port and the tank port, and in a second flow direction fluid is able to flow from the service port to the pressure port and the tank port, and the spool is controllable to variably restrict flow to the tank port. In the second operating configuration the spool is configured and arranged to close the tank port and define a fluid pathway connecting the pressure port and the actuator port, and the spool is controllable to variably restrict flow between the pressure port and the actuator port.

The first mode of operation enables off-load pump start-up wherein the pump is operated without being loaded by the lifting pressure. The tank port may be fully opened on start-up so there is no hydraulic restriction and the pump therefore operates without a load. This arrangement avoids the need for a separate bypass valve as can be found in arrangements of the prior art. In addition, the ability to operate the spool to variably restrict the tank port in the first operating configuration enables flow to the actuator to be initiated, while also allowing flow to tank for excess fluid not required when the flow demand of the actuator is less than the output flow of the pump when operating at the minimum operating speed recommended by the manufacturer. By incorporating the functions provided by the first and second operating configurations in a single spool valve the present invention provides significant improvements over the arrangements of the prior art which utilise multiple cartridge valves and significantly more complex control systems to provide the same functionality.

At the point the flow demand of the hydraulic actuator becomes greater than or equal to the minimum output flow of the pump the spool may then be operated in the second operating configuration in which flow to tank is closed and flow to the actuator controlled by controlling the speed of the pump. The second operating configuration may also be used during lowering where flow through the pump is required for the purpose of energy regeneration. The ability to operate the spool in the second operating configuration to variably restrict flow between the pressure port and the service port enables the flow from the actuator to the pump to be controlled.

Preferably the valve is reconfigurable to a third operating configuration in which the spool is configured and arranged to close the pressure port and define a fluid pathway between the service port and the tank port, and the spool is controllable to variably restrict flow between the service port and the tank port. This advantageously enables gravity lowering with flow from the actuator directly to tank. The ability to variably restrict the flow path allows the lowering speed to be controlled. The incorporation of the functionality achieved in the third operating configuration into the spool valve provides yet further advances over the prior art and removes the requirement for the additional valve and control arrangements that would be otherwise employed in the prior art to achieve the same functionality.

The spool is preferably configured such that in the first operating configuration the flow path between the pressure port and the service port remains fully open when flow to the tank port is variably restricted.

Preferably a controller is provided for controlling the axial position of the spool. The controller is therefore configured to move the spool between the first, second and third operating configurations.

The control valve assembly may further comprise biasing means arranged to bias the spool to the first operating configuration. The first operating configuration with the tank port fully open is therefore the default rest position of the spool. The controller operates the spool against the action of the biasing member to move the spool to variably restrict the tank port in the first operating configuration and to move the spool into the second and third operational configurations.

Preferably in a first supply mode of operation in which the spool is arranged in the first operating configuration during activation of the pump the tank port is open to permit flow from the pressure port to the tank port during pump activation. This corresponds to the full off-load start up position, with no flow going to the actuator.

In a second supply mode of operation, in which the spool is in the first operating configuration, the controller is configured to control the spool to proportionally close the tank port to share flow between the actuating port and the tank port when flow to the actuating port is initiated and the required supply flow to the actuator is less than the minimum supply flow of the pump. In this situation flow from the pump exceeds the actuator demand. Flow commences to the actuator and excess flow is directed to tank.

In a third supply mode of operation the controller may be configured to arrange the spool in the second operating configuration to close the tank port such that all flow from the pressure port is directed to the actuating port when the required supply flow to the actuator is equal to or greater than the minimum supply flow of the pump.

The controller is preferably configured to control the pump to increase in speed once the tank port is fully closed and the required supply flow to the actuator is greater than the minimum supply flow of the pump.

In a fourth supply mode of operation the controller is preferably configured to arrange the spool in the second operating configuration and to proportionally close the flowpath between the pressure port and the service port to throttle flow to the actuator from the pump when the required system pressure exceeds the required supply pressure to the actuator. This provides a simple and efficient means of enabling auxiliary actuators to be operated at a higher pressure than the primary actuator

In a fifth regenerative lowering mode of operation the controller may be configured to control the spool to move to the second operative configuration to allow fluid to flow from the actuator to the pump. In this arrangement the tank port is closed and a direct flowpath between the actuator and pump is created.

In the fifth regenerative lowering mode the controller is configured to control the spool to proportionally close the fluid flowpath between the pressure port and the service port to throttle flow from the actuator to the pump. This enables flow to the pump to be restricted to prevent overload of the battery during energy regeneration.

Preferably, in a sixth gravity lowering mode of operation the controller is configured to arrange the spool in the third operative configuration to allow fluid to flow directly from the service port to the tank port when energy regeneration via the pump is not required.

In the sixth gravity lowering mode of operation the controller may be configured to control lowering of the actuator by controlling the spool to proportionally close the fluid flowpath between the service port and tank port to throttle flow from the actuator to the tank.

The valve body preferably includes a pilot port arranged to receive pressurised fluid for controlling movement of the spool valve. The supply of pressurised fluid to the pilot port is controlled by the controller.

The control valve assembly may further comprise a proportional pressure reducing valve connected to the pilot port for controlling the fluid pressure at the pilot port. The proportional pressure reducing valve is controlled by the controller to control the supply of pressurised fluid to the pilot port.

The spool preferably includes a loading surface at a first end arranged such that pressurised fluid entering the pressure port applies a force to said loading surface to cause axial movement of the spool in a first direction and the biasing means is located at a second end of spool and arranged to impart a biasing force to the spool in an axially opposing second direction.

In another aspect of the invention there is provided a hydraulic control system for a load handling vehicle. The system comprises a hydraulic actuator; a pump; a tank reservoir; and a valve assembly as described above. The pump is fluidly connected to the pressure port of the valve, the hydraulic actuator is connected to the service port and the tank reservoir is connected to the tank port.

In a yet further aspect of the invention there is provided a vehicle including a hydraulic control system as described above.

In another aspect of the invention there is provided a method of flow control for a load handling vehicle comprising a first hydraulic actuator; a pump; a tank reservoir; and a valve assembly as described above. The pump is fluidly connected to the pressure port of the valve, the hydraulic actuator is connected to the service port and the tank reservoir is connected to the tank port. The method comprises selectively moving the spool axially along the bore between said three operating configurations.

The method may further comprise, in a first supply mode of operation, activating the pump with the spool arranged in the first operating configuration such that the tank port is open to permit flow from the pump to the tank during pump activation.

The method preferably comprises, in a second supply mode of operation, controlling the spool to proportionally close the tank port following activation of the pump to share flow between the actuator and the tank when the required supply flow to the actuator is less than the minimum supply flow of the pump.

The method preferably comprises, in a third supply mode of operation, controlling the spool when in the first operating configuration to close the tank port and directing all flow from the pump to the actuator when the required supply flow to the actuator is equal to or greater than the minimum supply flow of the pump.

The method preferably comprises increasing the speed of the pump when the tank port is fully closed and the required supply flow to the actuator is greater than the minimum supply flow of the pump.

The load handling vehicle preferably further comprises at least a second hydraulic actuator supplied with fluid by the pump, the method further comprising, in a fourth supply mode of operation, arranging the spool in the second operating configuration and controlling the spool to proportionally close the flowpath between the pressure port and the service port to throttle flow to the first actuator from the pump when the pressure required by the second actuator exceeds the required supply pressure to the first actuator.

The method may further comprise, in a fifth regenerative lowering mode of operation, arranging the spool in the second operative configuration to allow fluid to flow from the actuator to the pump.

The pump is preferably a pump generator, and the method may further comprise driving the pump generator using said fluid flow from the actuator and operating the pump generator to generate electricity.

The method may further comprise controlling lowering of the actuator by proportionally closing the fluid flowpath between the pressure port and the service port to throttle flow from the actuator to the pump.

The method may further comprise controlling the spool in a sixth gravity lowering mode of operation to arrange the spool in the third operative configuration to allow fluid to flow from the service port to the tank port when energy regeneration is not required.

The method may further comprise controlling lowering of the actuator by controlling the spool to proportionally close the fluid flowpath between the service port and tank port to throttle flow from the actuator to the tank.

The valve body preferably includes a pilot port and the method further comprises supplying pressurised fluid to the pilot port to control movement of the spool.

The present invention will now be described by way of example only with reference to the following illustrative figures in which:

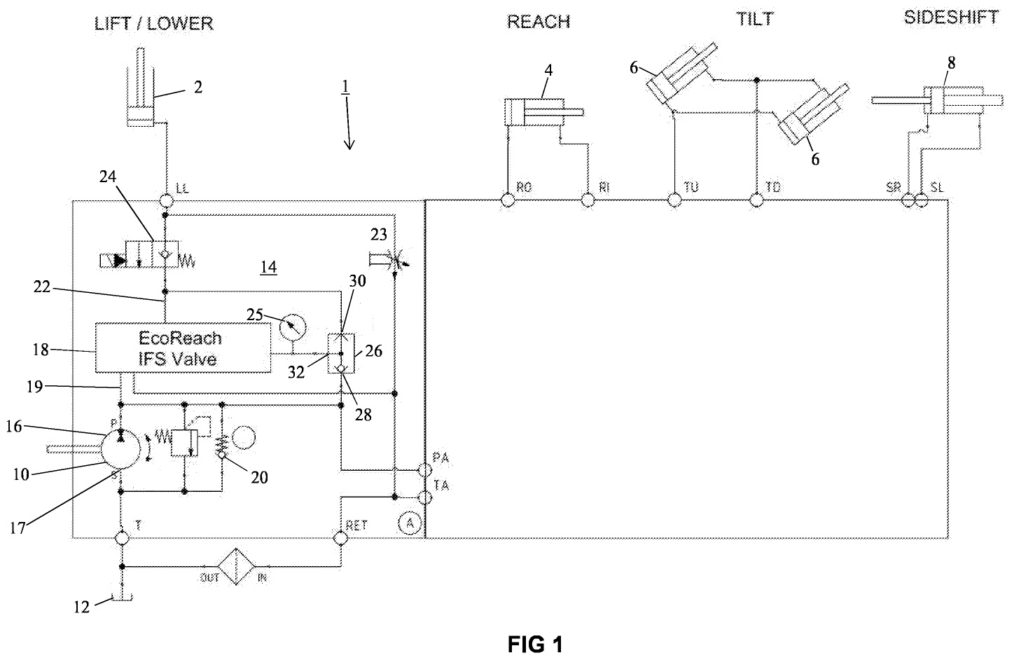

FIG. 1 is a circuit diagram of a hydraulic system according to an embodiment of the invention;

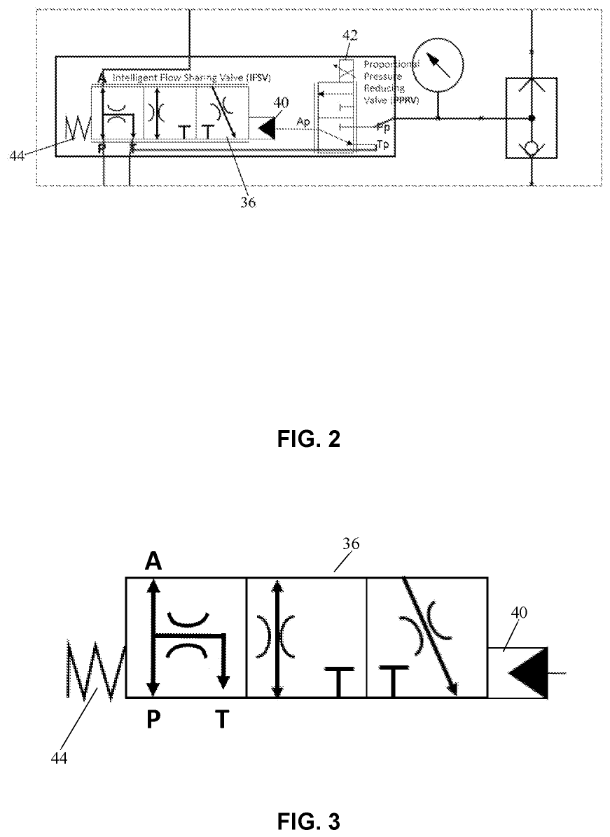

FIG. 2 is a schematic diagram of a valve according to an embodiment of the invention;

FIG. 3 is a schematic diagram of a valve according to an embodiment of the invention in a first operative configuration;

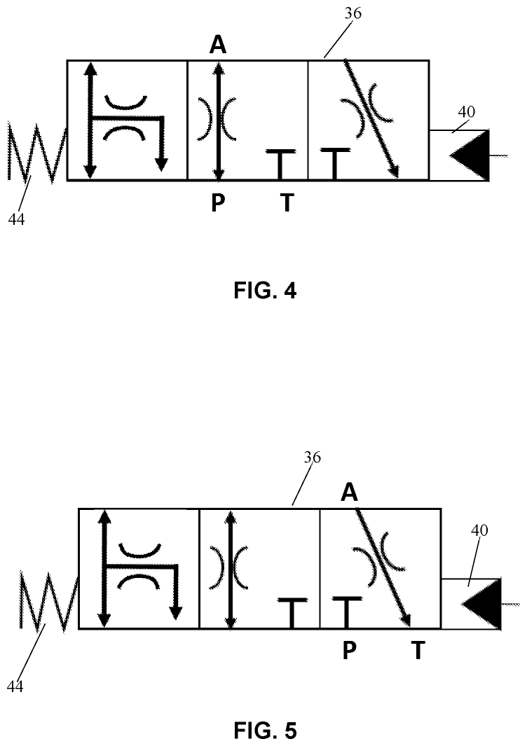

FIG. 4 is a schematic diagram of a valve according to an embodiment of the invention in a second operative configuration; and

FIG. 5 is a schematic diagram of a valve according to an embodiment of the invention in a third operative configuration;

FIG. 1 is a hydraulic circuit 1 for a load handling vehicle such as a forklift truck. The circuit comprises a primary hydraulic actuator 2 which in use in connected to lifting tines of the forklift truck, which are movably mounted to the mast of the vehicle. The circuit also includes a first auxiliary hydraulic actuator 4 which is arranged to perform a reach function in which the tines are moved forwards and backwards relative to the mast. Second auxiliary hydraulic cylinders 6 are arranged to tilt the mast of the vehicle to vary the angle of the load in the forwards and backwards direction. A third auxiliary hydraulic cylinder 8 is arranged to move the tines laterally side to side relative to the mast. It will be appreciated that this is an example of one arrangement of auxiliary functions, and that the circuit may include additional, or fewer auxiliary hydraulic cylinders depending on the operational requirements of the vehicle.

A pump motor 10 is provided to operate the primary and auxiliary hydraulic cylinders. In a supply mode of operation the pump motor 10 is configured to provide hydraulic flow/pressure to the hydraulic system 1 by rotating in a first supply direction and converting mechanical shaft power from the electric motor into hydraulic power. The pump motor 10 is also configured to operate in a regeneration mode in which it receives hydraulic flow/pressure from the system, causing the pump to rotate in a second regeneration direction. Hydraulic power is converted into mechanical shaft power, which is able to be converted to electrical energy. This bi-directional pump arrangement is referred to as a 2 Quadrant pump. The hydraulic system 1 further includes a tank reservoir 12.

A first manifold 14 is configured to control flow to the primary hydraulic cylinder 2 from the pump 10. Second and third manifolds 15 and 17 are also provided for controlling flow to the auxiliary hydraulic cylinders. The first manifold 14 includes a first pressure port 16 and second pressure port 17. In the supply mode, the first pressure port 16 is the outlet port of the pump 10, and the second port 17 is the pump inlet, supplying flow to the pump 10 from the tank 12. The first pressure port 16 is connected to spool valve 18, which is configured to intelligently share flow, via flow channel 19. The spool valve 18 controls flow to the first hydraulic actuator 2 from the pump 10. The spool valve 18 is connected to the first hydraulic actuator 2 via flow channel 22. A hydraulic load-holding valve 24 is provided between the spool valve 18 and the first hydraulic actuator 2. The valve 24 is configured to operate in a deactivated position and an activated position. In the de-activated position the valve 24 blocks flow from the first hydraulic actuator 2 to the spool valve 18 while allowing flow in the reverse direction from the spool valve 18 to the first hydraulic actuator 2. This enables the load on the first hydraulic actuator 2 to be held in position. In the activated position flow is able to pass from the first hydraulic actuator 2 to the pump 10 or tank 12.

An anti-cavitation check valve 20 is provided in the first manifold 12 as a safety feature. The fluid circuit also includes an emergency lowering valve 23 which is configured to provide throttled flow from the first hydraulic actuator 2 to tank 12 to safely lower the load in case of a system failure, such as an electrical failure in the control system.

A hydraulic pressure transducer 25 is provided to measure the load pressure on the forks. The hydraulic pressure transducer 25 may also be used as an input to the control system in order to further advance the control algorithms and optimize the activation/de-activation of certain hydraulic valves. A hydraulic shuttle valve 26 is also provided having inlet ports 28 and 30 and an outlet port 32. The valve 26 shuttles the highest pressure from the two inlet ports 28 and 30, from the pump 10 or first hydraulic actuator 2 respectively, to the outlet port 32, which supplies the spool valve 18.

FIG. 2 is an illustrative schematic view of the spool valve 18. The valve 18 comprises a valve body having an axial bore, and a spool 36 contained within the bore. The spool 36 is axially movable within the bore. Three operating configurations are schematically represented within spool 36 which illustrate the flow conditions in each of three operating positions corresponding to different axial positions of the spool along the bore relative to the pressure port P, service port A and tank port T. The spool valve 18 is pilot operated, and a pilot port 40 is provided at a first axial end of the spool 36 which is arranged to receive fluid from the outlet 32 of the shuttle valve 26. Flow to the pilot port 40 is controlled by a proportional pressure reducing valve (PPRV) 42, which proportionally varies the pressure at the pilot port 40 based on an electronic control signal provided to a coil within the valve 42.

The PPRV 42 is controlled by a controller operating a control algorithm configured to control the position of the spool 36 based on the flow demands and current operating parameters of the hydraulic system. The pressure at the pilot port 40 acts on the spool 36 to axially move the spool 36 in a first axial direction away from the pilot port 40. A biasing member 44 is provided at the opposing end of the spool 36, which is arranged to provide a biasing force in the opposing axial direction to the pilot pressure. The biasing member 44 may be a compression spring or any suitable biasing means. The biasing member 44 biases the spool 36 in a second axial direction towards the pilot port. In order to move the spool 36 in the first direction towards the biasing member 44 the pilot pressure must overcome the biasing spring force of the biasing member 44.

The valve body 34 comprises a pressure port P, which is connected to the pump 10 via the flow channel 19, a service port A connected to the first hydraulic actuator 2 via flow channel 22, and tank port T connected to the tank reservoir 12. The spool 36 is configured to move axially under the control of the pilot signal between three different operating positions. The spool 36 is configured to define different flow pathways between the ports P,A,T in the three operating positions.

In a first operating position shown in FIG. 3, the spool 18 is configured and arranged to define a fluid pathway connecting the pressure port P, the service port A and the tank port T. In the first position all three ports are connected such that in a first flow direction fluid is able to flow from the pressure port P to the service port A and the tank port T, and in a second flow direction fluid is able to flow from the service port A to the P and the tank port T. The spool 18 is controllable by the pilot signal when in the first position to variably restrict flow to the tank port T, as will be further described below.

In the first position the spool 36 functions in a first mode of operation to facilitate off-load pump start up. In a hydraulic system it is desirable for the hydraulic pump to start up ‘off-load’, meaning that the pump is not loaded by the lifting pressure while it begins to rotate. As such the hydraulic pump can be rotated to a certain speed before the load pressure is introduced and gradually increased. In arrangements of the prior art this is commonly achieved using bypass valves, but the inclusion of additional bypass valves add cost and complexity to the hydraulic system. Due to the cost competitive nature of the forklift industry the bypass valves are often left out of the hydraulic system. As a result, the hydraulic pumps are started on-load, without any gradual introduction of the load, which leads to premature wear of the hydraulic pump.

The first mode of operation of the spool valve 36 is controlled such that the pressure port P, tank port T and service port A are open. As such, when the pump 10 is initiated and begins to rotate, there is no load on the pump 10 as the fluid is able to flow to tank 12. As the first hydraulic actuator 2 is loaded, there is no flow to the service port A despite the port being open. With the tank port T fully open there is no hydraulic restriction and the pump 10 operates without a load. Enabling the pump 10 to start off-load in this way provides the same functionality as a separate bypass valve. The hydraulic pump 10 can be increased in the first mode of operation to a minimum rotational speed, for example a rotational speed correlating to an output flow of 5 lpm, without loading, due to all of the output flow being diverted to tank 12.

Following pump activation, with the pump 10 running at a speed corresponding to the minimum operating speed recommended by the pump manufacturer, flow to the first hydraulic actuator 2 via the service port A may be initiated. Output flow on service port A may be provided under two conditions. The first condition is where the flow demand of the first hydraulic actuator 2 is less than the minimum output flow of the pump 10, and the second being where the flow demand of the first hydraulic actuator 2 is greater than or equal to the minimum output flow of the pump 10. The spool 36 is operable under the control of the pilot signal to satisfy the flow demand under both conditions.

In a second mode of operation, as shown in FIG. 4, in which the pump 10 is running at a speed corresponding to the minimum operating speed recommended by the pump manufacturer and the required output flow on the service port A is less than minimum output flow, i.e. the bypassing flow (going back to port T), the full flow from the pump 10 exceeds the demand on the service port A and therefore the full flow of the pump 10 cannot be directed to the service port A.

The spool 36 is therefore controlled to proportionally close the tank port T such that the required flow is redirected to the service port A and the excess flow is continuing to flow to the tank port T. In this way the spool 36 operates the tank port T as a variable bleed orifice between the pressure port P and tank port T. Proportional closure of the tank port T creates flow sharing between port A and T, with port P as the inlet or flow supply. The spool 36 is controllable by the pilot signal to proportionally vary the degree to which the tank port T is closed depending on the actuator demand.

In the second mode of operation the flow to service port A is controlled between zero and the minimum output flow of the pump 10, e.g. from 0 to 5 LPM. This enables a creep speed of the forks in which the actuator flow at service port A is significantly less than the minimum required output flow (minimum rotational speed) of the pump 10 without causing damage to the pump. For example, the minimum rotational speed of an external gear pump under full load may be 500 RPM; the speed being set to ensure sufficient lubrication of the bearings to prevent damage. In typical forklifts a pump displacement of 23.0 cc/rev can be used. At 500 RPM this will give a theoretical output flow of 11.5 LPM. If the required output flow at the service port A is less than 11.5 LPM and the pump is caused to operate at this speed it may wear out prematurely.

In a third operating mode, at the point where flow to the service port A equals the minimum flow of the pump 10, the tank port T is able to be fully closed. Once the required output flow on service port A is equal to or greater that the minimum output flow of the pump 10, flow to the tank 12 is no longer required. The control algorithm of the controller will begin to control the spool 36 to proportionally shift the inlet flow provided on port P from the bypass flow to tank port T to actuator flow at service port A.

Once all the supply flow on pressure port P is redirected to service port A, and the tank port T is fully closed, flow to the service port A is controlled entirely by the speed of the pump 10. If the flow demand at the service port A exceeds the minimum output flow of the pump 10, the speed of the pump 10 will be increased in order to increase flow to the service port A.

In a second operating position, shown in FIG. 4, the spool 36 is configured such that a flow channel is defined between the pressure port P and the service port A, and the tank port T is closed. The spool 36 is controlled by the pilot signal to proportionally close the pressure port P and/or the service port A to create a control orifice between the pump 10 and first hydraulic actuator 2. As such, the spool 36 may be controlled to proportionally throttle flow between the pressure port P and service port A. In a fourth operating mode, throttling of the flow between the pressure port P and service port A may be implemented when flow sharing conditions are demanded between the first hydraulic actuator 2 and one or more of the auxiliary actuators 4,6,8. Without throttling, the hydraulic oil provided by the hydraulic pump will always choose the path of least resistance. Therefore, when flow to an auxiliary cylinder 4,6,8 is required at a pressure that exceeds the flow demand of the first actuator 2, flow to the first actuator 2 must be throttled to enable the system pressure to be raised to the level of the auxiliary demand pressure.

As an example, if the first actuator 2 requires 100 bar in order to lift the loaded forks, but the auxiliary cylinder 4 requires 150 bar to operate the reach function, in the absence of any flow sharing logic all the oil provided by the pump 10 will be directed to the lift function of the first hydraulic actuator 2. This results in the lift function over-speeding unexpectedly, whilst the reach function will not operate at all. In most hydraulic systems this is highly undesirable, and when simultaneous function is required some flow sharing logic needs to be built into the circuit. However, the additional components required for flow sharing capability typically results in a more complex and expensive system. In the fourth operating mode of the present invention flow sharing is achieved by controlling the spool 36 to throttle flow to the service port A in order to raise the system pressure to the auxiliary demand pressure. In the above example this would require the application of a 50 bar throttle to the flow to the service port A, such that pump operates at 150 bar while supply to the service port A is 100 bar. This results in 50 bar of throttling losses over the IFS spool valve 18, but enables simultaneous primary and auxiliary function (i.e. lift and reach) with the use of a single pump and without the requirement for complex and expensive additional valves and control systems.

In most flow sharing circuits the flow sharing is achieved by load-sense logic, which controls a pilot-operated logic element that can throttle the pressure differential across itself by varying the pilot signal. In a hydraulic system there will always be a pressure drop from the pump outlet port to the point in the system where the load-sense signal will be picked up. In order to off-set this pressure drop a spring bias needs to be introduced in the logic element in order for it to remain closed when not required. In some systems the bias spring force might need to be as high as 20 bar. Although operation of these valves is fairly simple, they have one major drawback. When simultaneous function is not required, to maximize the system efficiency the pressure drop through the logic element needs to be minimized. In the present invention, a bias spring is not necessary because the valve position can be throttled directly by spool 36 under the control of the pilot signal. As a bias spring is not required the valve can be positioned to its fully open position when simultaneous function is not required, resulting in a significant increase in system efficiency.

In the second operating position the flow direction may be reversed to provide flow from the service port A to the pressure port P. The spool 36 is operable to throttle the flow between the pressure port P and service port A bi-directionally, and can therefore throttle flow when flowing from the service port A to the pressure port P in the same manner as described above for flow from the pressure port P actuator to the port A. which means to throttle from port P to A as well as from A to P.

In a fifth mode of operation, flow may be provided from service port A to the pressure port P to enable the pressurised fluid from the first hydraulic actuator 2 to be used during lowering to drive the pump 10 for energy regeneration, in which the pump motor 10 operates as a hydraulic motor, converting hydraulic power into mechanical shaft power. Under these conditions it is desirable to be able to controllably initiate load to the pump 10, for example if the hydraulic unit is driven by an electric motor/generator such as an induction motor that has poor dynamic performance. The spool valve 18 enables initial lowering of the forks to be achieved in a fully hydraulic manner using the spool 36 to throttle flow from the service port A to the pressure port P. During this gravity lowering phase rotation of the electric motor/generator may be initiated unloaded, allowing torque to be ramped up before the gradual initiation of the regenerative motor/generator unit. More generally the use of the spool valve 18 allows improved controllability, especially when creep-speed lowering is desired.

The pump motor 10 may be used to generate electrical energy during regenerative lowering that is stored in a battery. During regenerative lowering the kinetic energy from the hydraulic fluid pressurised by the elevated load is converted from electrical energy by driving the pump motor 10 as a generator unit. Under certain operating conditions, such as where the forklift is predominantly lowering loads with limited lifting operation, the battery may become fully charged as energy regeneration exceeds electric energy consumption. Once the state of charge of the battery pack is 100%, overcharging may cause damage to the battery. In this scenario, the lowering flow may be throttled such that load is removed from the pump motor 10 to cease energy regeneration. The spool valve 18 therefore provides battery overcharge protection, whilst enabling the load to be lowered in a safe and controlled manner. In arrangements of the prior art, the hydraulic systems require separate logic element valves in order to enable throttling from the service port A to the pressure port P as such logic element valves can only be controlled unidirectionally, which again requires additional components and adds complexity and cost to the system.

In a sixth mode of operation, in the second operating position, the flow channel from the service port A to the pressure port P may be fully opened. Fully opening the flow channel from the service port A to the pressure port P minimises pressure drop through the spool valve 18 and maximises system efficiency. By controlling the spool 36 such that the flow channel from service port A to pressure port P is in its fully open state, all the kinetic energy available from the load can be used by the motor/generator for electric energy recovery, which maximises the energy saving potential compared to systems of the prior art.

In a third operating position, as shown in FIG. 5, the spool 36 is configured such that a flow channel is defined between the service port A and the tank port T, and the pressure port P is closed. The spool 36 is controlled by the pilot signal to proportionally close the tank port T and/or the service port A to create a control orifice between the tank 12 and first hydraulic actuator 2. As such, the spool 36 may be controlled to proportionally throttle flow between the service port A and the tank port 12 during lowering of the load.

The third operating position provides a more conventional gravity lowering means of lowering a load, without energy regeneration. During gravity lowering all the available kinetic energy is converted into heat in the oil by throttling the induced pressure down to atmospheric pressure by controlling the orifice in-between the service port A and tank port T. All flow from the first hydraulic actuator 2 goes directly to tank 12 rather than through the pump 10. Although very inefficient compared to the energy recovery mode of operation, there are specific advantages that may be achieved by gravity lowering in the third operating position.

The heat energy generated by flow throttling during gravity lowering is generally undesirable as heating up the hydraulic oil requires a more powerful cooling system on the hydraulics. However, in cases when the forklift trucks are used in a cold storage environment it might be feasible to switch back to a highly efficient system in order to use the kinetic energy from lowering to bring the hydraulic oil temperature into its operating zone as quick as possible. If energy recovery systems are implemented in forklift trucks the energy from lowering a load will be converted into useful electric energy, which inherently reduces the amount of heat transferred to the oil.

As described above, in certain circumstances regenerative lowering is not possible due to the battery being fully charged. Instead of throttled gravity lowering in the second operating position and free spinning the hydraulic pump 10, the spool valve 18 can be switched to the third operating position in which the lowering flow is throttled down directly to the tank 12. In this way the pump 10 does not need to be rotated, which reduces operation of the pump 10 and minimises system noise.

In a further advantage, the IFS valve of the present invention enables operation of the auxiliary cylinders during lowering, without the requirement for 4 Quadrant pump technology. During lowering of the first hydraulic cylinder 2 a simultaneous auxiliary function such as ‘reach’ may be required. The pump 10 is used during regenerative lowering to capture the available kinetic energy and use it to charge the batteries. If a simultaneous auxiliary function is required during a regenerative lowering event the induced load on the first hydraulic cylinder 2 may be used to operate the auxiliary functions if the pressure is sufficient to meet the auxiliary demand. However, if the induced pressure on the first hydraulic cylinder 2 is not sufficient, the pump 10 will be required to operate the auxiliary functions. It is possible to operate a pump to boost the pressure from the lowering cylinder as the lowering flow passes through the pump by loading the return line of the pump. However, this requires a change in pump technology from 2 Q (2 quadrant) to 4 Q (4 quadrant) which significantly increases cost and complexity and limits the pump technologies that can be used in such energy recovery systems.

In the present invention, where pump operation is required to supply the auxiliary cylinders during load lowering, the spool 36 may be moved to the third position to enable flow from first actuator 2 to tank 12, which bypasses the pump 10 and enables the pump 10 to be operated to supply the auxiliary demand.

1. A control valve assembly for a load handling vehicle, the control valve comprising:
a valve body having a bore;
a spool located within the bore that is axially movable along the bore between at least two operating configurations;
a service port formed in the valve body and arranged for connection to a hydraulic consumer such as a hydraulic actuator;
a pressure port formed in the valve body and arranged for connection to a hydraulic power provider such as a pump; and
a tank port formed in the valve body and arranged for connection to a hydraulic tank reservoir;
wherein in a first operating configuration the spool is configured and arranged to define a fluid pathway connecting the pump port, the service port and the tank port such that in a first flow direction fluid is able to flow from the pressure port to the service port and the tank port, and in a second flow direction fluid is able to flow from the service port to the pressure port and the tank port, and the spool is controllable to variably restrict flow to the tank port; and
in a second operating configuration the spool is configured and arranged to close the tank port and define a fluid pathway connecting the pressure port and the actuator port, and the spool is controllable to variably restrict flow between the pressure port and the actuator port.

2. A control valve assembly for a load handling vehicle according to claim 1 wherein in a third operating configuration the spool is configured and arranged to close the pressure port and define a fluid pathway between the service port and the tank port, and the spool is controllable to variably restrict flow between the
service port and the tank port.

3. A control valve assembly for a load handling vehicle according to claim 2 wherein the spool is configured such that in the first operating configuration the flow path between the pressure port and the service port remains fully open when flow to the tank port is variably restricted.

4. A control valve assembly for a load handling vehicle according to claim 3 further comprising a controller for controlling the axial position of the spool.

5. A control valve assembly for a load handling vehicle according to claim 4 further
comprising biasing means arranged to bias the spool to the first operating configuration.

6. A control valve assembly for a load handling
vehicle according to claim 4 wherein in a first supply mode of operation in which the spool is arranged in the
first operating configuration during activation of the pump and the tank port is open to permit flow from the pressure port to the tank port during pump activation.

7. A control valve assembly for a load handling vehicle according to 6 wherein in a
second supply mode of operation in which the spool is in the first operating configuration, the controller is configured to control the spool to proportionally close the tank port to share flow between the actuating port and the tank port when flow to the actuating port is initiated and the required supply flow to the actuator is less than the minimum supply flow of the pump.

8. A control valve assembly for a load handling vehicle according to claim 7 wherein in a third supply mode of operation the controller is configured to arrange the spool in the second operating configuration to close the tank port such that all flow from the pressure port is directed to the actuating port when
the required supply flow to the actuator is equal to or greater than the minimum supply flow of the pump.

9. A control valve assembly for a load handling vehicle according to claim 8 wherein the controller is configured to control the pump to increase in speed once the tank port is fully closed and the required supply flow to the actuator is greater
than the minimum supply flow of the pump.

10. A control valve assembly for a load handling vehicle according to claim 4 wherein in a fourth supply mode of operation the controller is configured to arrange the spool in the second operating configuration and to proportionally close the flowpath between the pressure port and the service port to throttle flow to the actuator from the pump when the required system pressure exceeds the required supply pressure to the actuator.

11. A control valve assembly for a load handling vehicle according to claim 3 wherein in a fifth regenerative lowering mode of operation the controller is configured to control the spool to move to the second operative configuration to allow fluid to flow from the actuator to the pump.

12. A control valve assembly for a load handling vehicle according to claim 11
wherein in the fifth regenerative lowering mode the controller is configured to control the spool to proportionally close the fluid flowpath between the pressure port and the service port to throttle flow from the actuator to the pump.

13. A control valve assembly for a load handling vehicle according to claim 3 wherein in a sixth gravity lowering mode of operation the controller is configured to arrange the spool in the third operative configuration to allow fluid to flow directly from the service port to the tank port when energy regeneration via the pump is not required.

14. A control valve assembly for a load handling vehicle according to claim 13 wherein in the sixth gravity lowering mode of operation the controller is configured to control lowering of the actuator by controlling the spool to proportionally close the fluid flowpath between the service port and tank port to throttle flow from the actuator to the tank.

15. A control valve assembly for a load handling vehicle according to claim 1 wherein the valve body includes a pilot port arranged to receive pressurised fluid for controlling movement of the spool valve.

16. A control valve assembly for a load handling vehicle according to claim 15 further
comprising a proportional pressure reducing valve connected to the pilot port for controlling the fluid pressure at the pilot port.

17. A control valve assembly for a load handling vehicle according to claim 15 wherein the spool includes a loading surface at a first end arranged such that
pressurised fluid entering the pressure port applies a force to said loading surface to cause axial movement of the spool in a first direction and the biasing means is located at a second end of spool and arranged to impart a biasing force to the spool in the opposing axial direction in an axially opposing second direction.

18. A hydraulic control system for a load handling
vehicle, the system comprising: a hydraulic actuator;
a pump;
a tank reservoir; and
a valve assembly according to claim 1;
wherein the pump is fluidly connected to the pressure port of the valve, the hydraulic actuator is connected to the service port and the tank reservoir is connected to the tank port.

19. A vehicle including the hydraulic control system of claim 18.

20. A method of flow control for a load handling vehicle comprising a first hydraulic actuator; a pump; a tank reservoir; and a valve assembly according to any preceding claim wherein the pump is fluidly connected to the pressure port of the valve, the hydraulic actuator is connected to the service port and the tank reservoir is connected to the tank port; the method comprising:
selectively moving the spool axially along the bore between said three operating configurations.

21. A method of flow control for a load handling vehicle according to claim 20, the
method further comprising, in a first supply mode of operation, activating the pump with the spool arranged in the first operating configuration such that the tank port is open to permit flow from the pump to the tank during pump activation.

22. A method of flow control for a load handling vehicle according to claim 21 further comprising, in a second supply mode of operation, controlling the spool to proportionally close the tank port following activation of the pump to share flow between the actuator and the tank when the required supply flow to the actuator is less than the minimum supply flow of the pump.

23. A method of flow control for a load handling vehicle according to claim 21 further comprising, in a third supply mode of operation,
controlling the spool when in the first operating configuration to close the tank port and directing all flow from the pump to the actuator when the required supply flow to the
actuator is equal to or greater than the minimum supply flow of the pump.

24. A method of flow control for a load handling vehicle according to claim 23 further comprising increasing the speed of the pump when the tank port is fully closed and the required supply flow to the actuator is greater than the minimum supply flow of the pump.

25. A method of flow control for a load handling vehicle according to claim 20 wherein the load handling vehicle further comprises at least a second hydraulic actuator supplied with fluid by the pump, the method further comprising, in a fourth supply mode of operation, arranging the spool in the
second operating configuration and controlling the spool to proportionally close the flowpath between the pressure port and the service port to throttle flow to the first actuator from the pump when the pressure required by the second actuator exceeds the required supply pressure to the first actuator.

26. A method of flow control for a load handling vehicle according to claim 21 further comprising, in a fifth regenerative lowering mode of operation, arranging the spool in the second operative configuration to allow fluid to flow from the actuator to the pump.

27. A method of flow control for a load handling vehicle according to claim 26 wherein the pump is a pump generator, the method further comprising driving the pump generator using said fluid flow from the actuator and operating the pump generator to generate electricity.

28. A method of flow control for a load handling vehicle according to claim 26 further comprising controlling lowering of the actuator by proportionally closing the fluid flowpath between the pressure port and the service port to throttle flow from the actuator to the pump.

29. A method of flow control for a load handling vehicle according to claim 28 further comprising controlling the spool in a sixth gravity lowering mode of operation to arrange the spool in the third operative configuration to allow fluid to flow from the service port to the tank port when energy regeneration is not required.

30. A method of flow control for a load handling vehicle according to claim 29 further comprising controlling lowering of the actuator by controlling the spool to proportionally close the fluid flowpath between the service port and tank port to throttle flow from the actuator to the tank.

31. A method of flow control for a load handling vehicle according to claim 21 wherein
the valve body includes a pilot port and the method further comprises supplying pressurised fluid to the pilot port to control movement of the spool.
